(19) United States
(12) Patent Application Publication
(10) Pub. No.: US 2008/0122197 A1
(43) Pub. Date: May 29, 2008

(54) ATV off-road sleeping/camping trailer

(76) Inventor: Nicholas Anthony Spence, Evergreen, CO (US)

Correspondence Address: BARBER LEGAL, P.O. BOX 16220, GOLDEN, CO, 80402-6004, US

(21) Appl. No.: 11/899,977

(22) Filed: Sep. 8, 2007

Related U.S. Application Data
(63) Continuation-in-part of application No. 11/082,603, filed on Mar. 15, 2005, now abandoned.

(51) Int. Cl. B60P 3/06

(52) U.S. Cl. 280/400; 280/656

(57) ABSTRACT

A folding camping trailer for use with an ATV. The trailer is of rugged construction and uses low inflation tires, and is large enough, when unfolded, to allow at least one sleeper. The interior is equipped with camping equipment such as stove, lantern, lights, toilet, equipment lockers, water, sink, heater and the like. Importantly, the trailer is dimensioned and configured to take up a foot print similar to that of an ATV, so that a standard garage or trailer dimensioned and configured to hold ATVs may hold the camping trailer in an ATV space. The trailer may have an extendible yoke, a torsional axle, and additional beds.

### CROSS-REFERENCE TO RELATED APPLICATIONS

This application claims the priority and benefit of copending U.S. patent application Ser. No. 11/082,603, filed Mar. 15, 2005, in the name of the same inventor, Nicholas Anthony Spence, and entitled ATV OFF-ROAD SLEEPING/CAMPING TRAILER, the entirety of which is incorporated herein by this reference.

### FIELD OF THE INVENTION

This invention relates generally to camping trailers and specifically to off road camping trailers.

### STATEMENT REGARDING FEDERALLY FUNDED RESEARCH

This invention was not made under contract with an agency of the US Government, nor by any agency of the US Government.

### BACKGROUND OF THE INVENTION

The modern all terrain vehicle (“ATV”) is used for utility and sports by a large number of people who need to get far off road for their activities. For example, ATVs are used on ranches, farms, ex-urban industrial sites, for surveys, oil field work and so on.

However, one major segment of the ATV market is for the sportsman or outdoor enthusiast. Hunters, individuals out fishing, climbing, or just enjoying the outdoors all use ATVs for easy transport in roadless areas.

The United States Forest Service in fact has special definitions of off-road vehicles, defined in terms of width of vehicle, width of trail and so on. These definitions provide a legal framework for recognition of ATV use on public lands and also may serve to help define general ATV terminology.

In particular, US government regulations differentiate trail-legal trailers from street-legal trailers, it being a violation of the law to use trailers of greater than 50 inches in width and 90 inches in length on “trails”. Note that trails are distinguished from back country roads, “off-road” trailers are legally NOT the same as trail-legal trailers.

A number of types of trailers have been popularized for use with ATVs. A patentability search yields a cross section of the types of trailers available to ATV users.

A small group of patents is on “ATV trailers” in general. U.S. Pat. No. 5,222,753 issued Jun. 29, 1993 to Parish, U.S. Pat. No. 5,513,868 issued May 7, 1996 to Barr, U.S. Pat. No. 5,782,490 issued Jul. 21, 1998 to Kendall et al, U.S. Pat. No. 6,378,904 issued Apr. 30, 2002 to Niehoff, U.S. Pat. No. D471,845 issued Mar. 18, 2003 to Mighell, U.S. Pat. No. 6,557,882 issued May 6, 2003 to Harrington, U.S. Pat. No. 6,739,617 issued May 25, 2004 to Martin are in this group. Some are for carrying ATVs and thus wholly unrelated to the invention. These items have various deficiencies against the invention, for example the '617 reference to Martin cannot fit on top of an ATV trailer (that is, on top of itself), nor can it legally fit onto an ATV trail, as it is not “ATV sized” as claimed herein in terms of inches of width and length.

Others may be relevant in that they show trailers for use behind an ATV. However, all of these trailers are more or less “utility” trailers designed to haul cargo (or cargo and a passenger) and are not structurally equipped as the trailer of the present invention is. It appears that there has never prior to the present invention been any ATV sized camping trailer.

One group teaches different types of trailer hitches, yokes, and so on. U.S. Pat. No. 3,314,692 issued Apr. 18, 1967 to Karns, U.S. Pat. No. 3,480,320 issued Nov. 25, 1969 to Turner et al, U.S. Pat. No. 4,331,346 issued May 25, 1982 to Walters, U.S. Pat. No. 5,082,307 issued Jan. 21, 1992 to Hollingworth, Jr., U.S. Pat. No. 6,286,854 issued Sep. 11, 2001 to Cross, and U.S. Pat. No. 6,712,381 issued Mar. 30, 2004 to Moss show various hitches and yokes. Some of these are not relevant to ATV trailers, as they do not relate to ATVs at all.

Another family included shows different types of normal camping trailers for road use. U.S. Pat. No. 2,957,482 issued Oct. 25, 1960 to Tomek, one of the oldest patents, is of interest for its general configuration, not the details of structure and construction. U.S. Pat. No. 3,420,567 issued Jan. 7, 1969 to Christensen, is of lesser interest, while U.S. Pat. No. 3,455,596 issued Jul. 15, 1969 to Krutzikowsky, U.S. Pat. No. 3,674,305 issued Jul. 4, 1972 to Steury, and U.S. Pat. No. 4,448,453 issued May 15, 1984 to Irelan et al are all of the more usual configurations used on road trailers. Significantly, NONE of these trailers are optimized and structured for use with an ATV, and all show details which argue away from use with an ATV.

Some patents show various axle arrangements for trailers. U.S. Pat. No. 4,415,181 issued Nov. 15, 1983 to McCall et al and U.S. Pat. No. 5,378,010 issued Jan. 3, 1995 to Marino et al are examples of this.

A few patents relate to materials, but don't seem to show extremely rugged materials necessary for off road use. U.S. Pat. No. 2,848,274 issued Aug. 19, 1958 to Geisler et al, U.S. Pat. No. 3,574,390 issued Apr. 13, 1971 to Metsker, U.S. Pat. No. 3,879,240 issued Apr. 22, 1975 to Wall are examples of this.

Finally, there is a substantial group of “miscellaneous” patents. U.S. Pat. No. 404101 issued May 28, 1889 to McMASTER, U.S. Pat. No. Des. 90,816 issued Oct. 3, 1933 to Parrish, U.S. Pat. No. 3,393,922 issued Jul. 23, 1968 to Adams, U.S. Pat. No. 4,706,991 issued Nov. 17, 1987 to Miller may be of interest.

Yet none of these devices provide any suggestion whatsoever to combine ATV “off-road” features with sleeper camper “on-road” features.

It would be advantageous to provide a trailer that is “ATV sized” for convenient storage and trailering in place of an ATV.

It would further be advantageous to provide an actual sleeping/camping equipped trailer dimensioned and configured to be stored and transported as an ATV equivalent load.

It would further be advantageous to provide an actual sleeping/camping equipped trailer equipped for rugged off road use and in particular, for being pulled behind an ATV.

It would further be advantageous to provide an actual camping equipped trailer sized to be equivalent to an ATV but able to fold out to increase in size enough to allow at least one camper to sleep therein.

It would further be advantageous to provide an actual camping equipped trailer sized to be equivalent to an ATV but able to fold out to increase in size enough to allow at least two campers to sleep therein.

### SUMMARY OF THE INVENTION

General Summary

A folding camping trailer for use with an ATV. The trailer is of rugged construction and uses low inflation tires, and is large enough, when unfolded, to allow at least one sleeper. The interior may optionally be equipped with camping equipment such as stove, lantern, lights, toilet, equipment lockers, water, sink, heater and the like. Importantly, the trailer is dimensioned and configured to take up a foot print similar to that of an ATV, so that a standard garage or trailer dimensioned and configured to hold ATVs may hold the camping trailer in an ATV space. The trailer may have an extendible yoke, a torsional axle, and additional beds.

Summary in Reference to Claims

It is therefore a first aspect, advantage, objective and embodiment of the present invention to provide an ATV trailer comprising:
1) a body having a front and a back and a bottom and a left side and a right side;
2) at least two wheels, each wheel having thereon at least one low inflation tire; one wheel disposed at each side of the body;
3) a foldable superstructure on the body, the superstructure having a first folded position and a second unfolded position in which the superstructure has an interior and an exterior;
4) a first bed affixed to the body within the interior of the superstructure.

It is therefore yet another aspect, advantage, objective and embodiment of the present invention to provide an ATV trailer, wherein the body, the axle, the wheels, and the superstructure when in the first folded position substantially the size and shape of an ATV.

It is therefore yet another aspect, advantage, objective and embodiment of the present invention to provide an ATV trailer further comprising:
5) a towing yoke having a first position having a first length and a second position having a second length.

It is therefore yet another aspect, advantage, objective and embodiment of the present invention to provide an ATV trailer further comprising:
6) a torsional axle connected to the body and wheels.

It is therefore yet another aspect, advantage, objective and embodiment of the present invention to provide an ATV trailer wherein the axle and wheels are dimensioned and configured to maintain the bottom at least ten inches (25 cm) above the lowest point of the low inflation wheels.

It is therefore yet another aspect, advantage, objective and embodiment of the present invention to provide an ATV trailer wherein the folding superstructure interior is no more than 90 inches long in one dimension when in the second unfolded position.

It is therefore yet another aspect, advantage, objective and embodiment of the present invention to provide an ATV trailer wherein the axis of fold of the superstructure extends from the front of the body to the back of the body.

It is therefore yet another aspect, advantage, objective and embodiment of the present invention to provide an ATV trailer wherein the bed further comprises a first folding bed having a substantially flat surface and at least one edge, the first folding bed having at least one hinge rotatably connecting the one edge of the first folding bed and a first side of the body, so that when the superstructure is in the first folded position the bed is atop the body and when the superstructure is in the second unfolded position the bed extends horizontally from the first side of the body.

It is therefore yet another aspect, advantage, objective and embodiment of the present invention to provide an ATV trailer wherein the superstructure further comprises a second folding bed having a substantially flat surface and at least one edge, the second folding bed having at least one hinge rotatably connecting the one edge of the second folding bed and a second side of the body, so that when the superstructure is in the first folded position the bed is atop the first folding bed and when the superstructure is in the second unfolded position the bed extends horizontally from the second side of the body.

It is therefore yet another aspect, advantage, objective and embodiment of the present invention to provide an ATV trailer further comprising:
a skid plate located under the axle and attached to the frame.

It is therefore yet another aspect, advantage, objective and embodiment of the present invention to provide an ATV trailer further comprising:
at least one stabilizer having a first position and a second position, the stabilizer in the first position rigidly extending from the ATV trailer to the surface on which it sits.

It is therefore yet another aspect, advantage, objective and embodiment of the present invention to provide an ATV trailer further comprising:
at least one bed panel support having a first position and a second position, the bed panel support in the first position rigidly extending from the ATV trailer to the surface on which it sits.

It is therefore yet another aspect, advantage, objective and embodiment of the present invention to provide an ATV trailer further comprising:
a length no greater than 90 inches.

It is therefore yet another aspect, advantage, objective and embodiment of the present invention to provide an ATV trailer further comprising:
a folded position width no greater than 50 inches.

It is therefore yet another aspect, advantage, objective and embodiment of the present invention to provide an ATV trailer further comprising:
7) camping equipment affixed to the body within the interior of the superstructure.

It is therefore yet another aspect, advantage, objective and embodiment of the present invention to provide an ATV trailer comprising:
1) a body having a front and a back and a bottom and a left side and a right side;
2) at least two wheels, each wheel having thereon at least one low inflation tire; one wheel disposed at each side of the body;
3) a first bed affixed to the body.

It is therefore yet another aspect, advantage, objective and embodiment of the present invention to provide an ATV trailer:
1) a body having a front and a back and a bottom and a left side and a right side;
2) at least two wheels, each wheel having thereon at least one low inflation tire; one wheel disposed at each side of the body;
3) a first bed affixed to the body;
   wherein the body has a length no greater than 90 inches and a width no greater than 50 inches.

### BRIEF DESCRIPTION OF THE DRAWINGS

FIG. 1 is a side view of a first embodiment of the trailer according to the invention, in the folded position.

FIG. 2 is a rear view of the first embodiment of the trailer, without wheels or tires, in the folded position.

FIG. 3 is a side view of the first embodiment of the trailer of the invention, in the unfolded position.

FIG. 4 is a rear view of the first embodiment of the trailer of the invention, in the unfolded position.

FIG. 5 is a side view of a second embodiment of the trailer of the invention, in the unfolded position.

FIG. 6 is a rear view of the a second embodiment of the trailer of the invention in the unfolded position.

FIG. 7 is a detail partial view of a first side hinge allowing unfolding of the trailer and first side bed.

FIG. 8 is a detail partial view of a second side hinge allowing unfolding the trailer and second side bed.

FIG. 9 is a detail partial view of one extendible yoke of the invention.

FIG. 10 is a planform view of the framework, skid plate and axle of the invention.

FIG. 11 is a side view (yoke omitted) of the framework, skid plate and axle of the invention.

FIG. 12 is a detail view of an auxiliary tow loop of the invention.

FIG. 13 is a partial side view of a stabilizer bar and adjoining area of the invention.

FIG. 14 is a partial rear view of a stabilizer bar and adjoining area of the invention.

FIG. 15 is a detail side view of a top and body latch of the invention showing latch guards.

FIG. 16 is a detail plan view of a top and body latch and latch guards of the invention.

FIG. 17 is a partial rear view of a lift arm embodiment of the invention.

FIG. 18 is a partial rear view of the lift arm embodiment of the invention.

FIG. 19 is a rear view of a third embodiment of the invention.

FIG. 20 is a partial side view of the third embodiment of the invention.

FIG. 21 is a partial side view of a rotation member of the superstructure of the invention.

FIG. 22 is a rear view of a fourth embodiment of the invention.

FIG. 23 is a plan view of the fourth embodiment of the invention.

FIG. 24 is a partial rear view of the fourth embodiment of the invention showing folding.

FIG. 25 is a partial rear view of the fourth embodiment of the invention showing folding at a different stage.

FIG. 26 is a rear view of a fifth embodiment of the invention.

FIG. 27 is a planform top view of an embodiment of the invention.

FIG. 28 is a plan view of a sixth embodiment of the invention, showing interior options.

FIG. 29 is a rear view of the sixth embodiment of the invention, showing interior options.

FIG. 30 is a side view of a seventh embodiment of the invention.

FIG. 31 is a partial rear view of an eighth embodiment of the invention, showing a queen size folding bed embodiment.

FIG. 32 is a partial rear view of the eighth embodiment in a different state of unfolding.

### INDEX TO REFERENCE NUMERALS

ATV camping trailer 1
Wheel 10
Low inflation tire 11
Cargo/passenger rack 12
Support 13
Body 14
Body front 14a
Body back 14b
Body bottom 14c
Frame 15
Yoke 16
Body doorway 21
Road safety equipment 22
Bed panel support 31
Stabilizer 32
Stabilizer foot 32a
Hard top 33
Superstructure 34
Torque bar 35
Superstructure 40
Superstructure doorway 41
Suspension 42
Elbow locking sleeve 43
Folding step 51
Electrical outlet panel 52
Portable generator 53
Hose bib 54
Interior 62
Right bed panel 71
Pivot 72
Hinge plate 73
Hinge arm 74
Right side 75
Superstructure support member 76
Pivot 77
Left bed panel 81
Pivot 82
Hinge plate 83
Side rail 91a, 91b
Cross beam 92a, 92b
Yoke extending portion 93
Yoke fixed portion 94
Hinge pin 95
Yoke hole 96
Pull pin 97
Spring 98
Pull pin handle 99
Torsion axle mount 101
Torsion axle 102
Skid plate 103
Torsion axle mount 111
Torsion axle 112
Skid plate 113
Frame member 121
Tow loop 122
Aperture 123
Fixed stabilizer portion 131
Extending stabilizer portion 132
Stabilizer brace 133
Stabilizer pivot 134
Fixed stabilizer portion 141
Extending stabilizer portion 142
Stabilizer brace 143
Latch 151
Latch protector 152
Latch 161
Latch protector 162
Lid 171
Body 172
Upper lift arm 173
Lower lift arm 174
Gas shock 175
Elbow locking sleeve 176
Lid 181
Trailer box (body) 182
Upper lift arm 183
Lower lift arm 184
Lift arms 185, 186
Ridge support 191
Side canopy support 192
Ridge to end/side canopy support 193
Ridge to side canopy support 201
Ridge support 202
Side canopy support 203
Bed panel 204
Side canopy support 211
Ridge to side canopy support 212
Rotatable sleeve 213
Fixed round protruding guide 214
Compression bushings 215
Bi-fold bedding platform 221
Single bedding platform 222
Bed support 223
Ridge canopy support 224
Ridge canopy support lower portion 224a
Ridge canopy support upper portion 224b
Body 231
Bi-fold bed panel interior section 232
Exterior fold bed panel 233
Bed panel 234, 235, 235a, 235b
Tire 261
Body 262
Exterior superstructure lift arms 263
Door 264
Bed 265
Trailer 271
Cargo rack 272
Cantilevered side interior seats 281
First bed 282
Second bed 283
Table 284a
Oven 284b
Interior well 285
Stove 286
Sink 287
Cantilevered side 291
Bed 292a, 292b
Floor panel 293
Table surface 294
Equipment/well 295
Superstructure 301
External tent 302
Stove/heater 303
Body 311
First bed panel 312
Third bed panel 313
hinged connection 314
Folding mechanism 315
Position 316
Side 321
Second bed first panel 322
Second bed extension hinge 323
Secondary panel hinge 324
Second bed first panel support 325
Second bed second panel support 326

### DETAILED DESCRIPTION

The applicant hereby exercises their right to be their own lexicographer: “It is well settled that a patent applicant may be his own lexicographer.” W. L. Gore and Associates v. Garlock, Inc. 721 F.2d. 1540, 220 USPQ 303, 316 (Fed. Cir. 1983), cert denied by US Supreme Court, 469 U.S. 851 (1984)”. For purposes of this application, an “ATV sized” vehicle or vehicle body is one which 1) meets forest service regulations for “on trail” or “trail-legal” use, 2) may conveniently fit on top of an “ATV hauler” such as that of U.S. Pat. No. 6,739,617 issued to Martin (note that the device of the '617 patent, which is designed to haul an ATV sized vehicle on top of itself, is presumably too large to fit on top of itself), 3) has a length less than 90 inches and a width less than 50 inches.

In general, the Forest Service defines an “ATV” or “All Terrain Vehicle” as being a “motorized, off-road vehicle 50 inches or less in width and having a dry weight of 600 pounds or less that travels on three or more low-pressure tires with a seat designed to be straddled by the operator. Low pressure tires are 6 inches or more in width and designed for use with wheel rim diameters of 12 inches or less, utilizing an operating pressure of 10 pounds per square inch (psi) or less as recommended by the vehicle manufacturer.” (FSH 2309.18).

Thus legally speaking ATV vehicles are extremely different vehicles from on-road vehicles. In particular, the reference to 50 inches or less in width, 600 pounds or less in weight virtually eliminates any commonality with on-road vehicles. For comparison, even small “SUV” or “JEEP” type vehicles are normally at least 5 to 6 feet in width and well over one ton in weight. Due to these size restrictions, ATVs are not normally legal for travel on public roads, while most Forest Service trails designated for ATV use are not legal for travel by on-road or “off-road” sized vehicles. Due to these size restrictions, it in turn is not obvious that the size of a street-legal camping trailer can be reduced (“optimized”) to the point that the trailer is the size of an ATV which is not street-legal. Such a reduction in size would violate the fundamental principle of operation and existence of the street legal trailer.

In particular, vehicles optimized in size to have ATVs carried atop them (such as the '617 reference) are simply not relevant prior art against the vehicle optimized to be carried on the top (the ATV vehicle). ATV vehicles are simply different vehicles from street-legal vehicles, and “optimization” of street-legal vehicles does not produce ATV vehicles.

As the CCPA noted in laying out an exception to the “optimization” principle, in In re Antonie, 559 F.2d 618, 195 USPQ 6 at 8, (CCPA, 1977), “This sort of experiment was not suggested by the teaching of (the prior art) “El-Naggar” since he was not trying to maximize or control (the variable in question) “treatment capacity”.” Thus the CCPA has stated that one exception to the principle of “optimization” occurs when the prior art does not suggest optimization of the variable in question. This is particularly important in the present case, in which the size difference results in vehicles which the US government legally differentiates.

Thus the applicant believes that legally an ATV and an on-road vehicle are different, and a trailer body may meet US governmental regulations differentiating trail-legal trailers from street-legal trailers by being trail-legal and not street-legal. Note that legally, an “off road” vehicle or trailer is STILL not “trail legal” according to US governmental regulations.

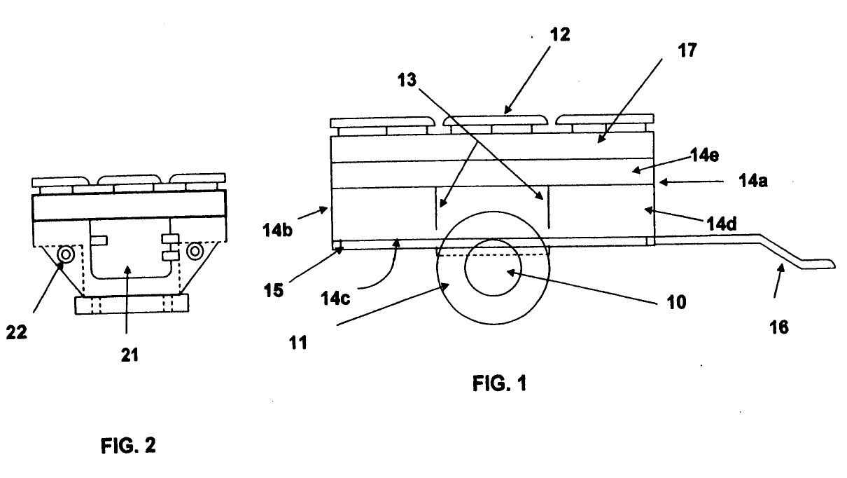

FIG. 1 is a side view of a first embodiment of the trailer according to the invention, in the folded position. ATV camping trailer 1 has wheel 10 having low inflation tire 11 thereon.

Low inflation tires are superior to regular tires used on road vehicles as they provide various benefits in off road travel. Low inflation tires tend to be wider and have a more aggressive tread than road tires, but importantly, low inflation tires automatically “spread” to cover any obstacle, thus reducing the chance of high ground pressures from occurring. Ground pressure per area is a key measure of off-road capabilities, as high ground pressure causes tires to sink into snow, ice, slush, mud, soft dirt, sand and the like. Low ground pressure tires on the other hand, distribute weight better and thus do not as easily sink into poor surfaces. For purposes of this invention, low inflation tires of a first category may be considered to be any tire having an approved inflation pressure of less than 24 pounds per square inch, a second category of low inflation tires may have an inflation pressure less than 18 pounds per square inch, and a third category of low inflation tires has a ground pressure under 12 pounds per square inch. Significantly, the inventor has not located a single example of a camping trailer having low inflation tires.

Cargo/passenger rack 12 on the top of the trailer allows passengers to ride atop the trailer when in use, or allows stowage of equipment or cargo atop the trailer.

Support 13 provides strength to a portion of the body which is cantilevered out to the sides.

Body 14 has a body front 14a, a body back 14b, a body bottom 14c, body side 14d and body side projection 14e, which projects further than the body side 14d to the side, since it may pass over, around, in front of or behind the low inflation tire 11. In the presently preferred embodiments and best modes now contemplated, the projection is made above the tires so that ground clearance to the sides is not an issue, nor is clearance in front or behind the tires. In other embodiments, the tires may sit in wells, the projection may be greater, the projection may be eliminated, the tires may sit entirely below the bottom of the vehicle, etc. In embodiments, support 13 may be omitted.

Frame 15 is the main structural strength element of the invention, a framework of tubes of square, circular, I-beam, C-beam, L-beam, box beam, or other cross section. While body 14 is advantageously comprised of a layered material designed for strength (such as panels of metal honeycomb construction), other construction is possible, for example, extremely durable metal sheets. However, a thin outer layer, thin inner layer and honeycomb layer sandwiched therebetween is the presently preferred construction due to high impact resistance, high strength, rigidity and low weight properties. Without wishing to be bound by any particular theory, it is believed that metal sheets, being much heavier than a honeycomb construction of three components (inner layer, outer layer, honeycomb) would impose towing penalties and durability penalties. Fiberglass/frame construction on the other hand, a choice of structure often used in on-road camper design, simply lacks the strength for rugged off road use, and especially the impact resistance necessary for devices which are expected to get knocked about a good deal.

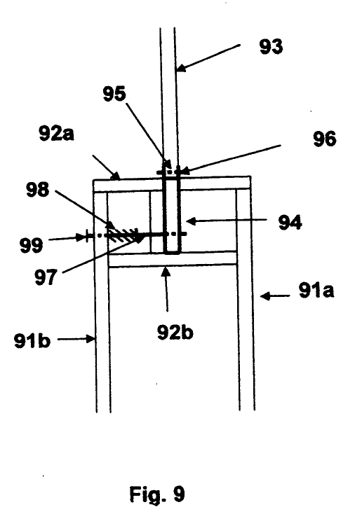

Yoke 16 is dimensioned and configured to accept standard tow arrangements such as balls of one size or the other, square hitches, etc. In addition, it is important to the usability of the ATV camping trailer that yoke 16 be of variable length, a feature discussed in more detail in relation to FIG. 9.

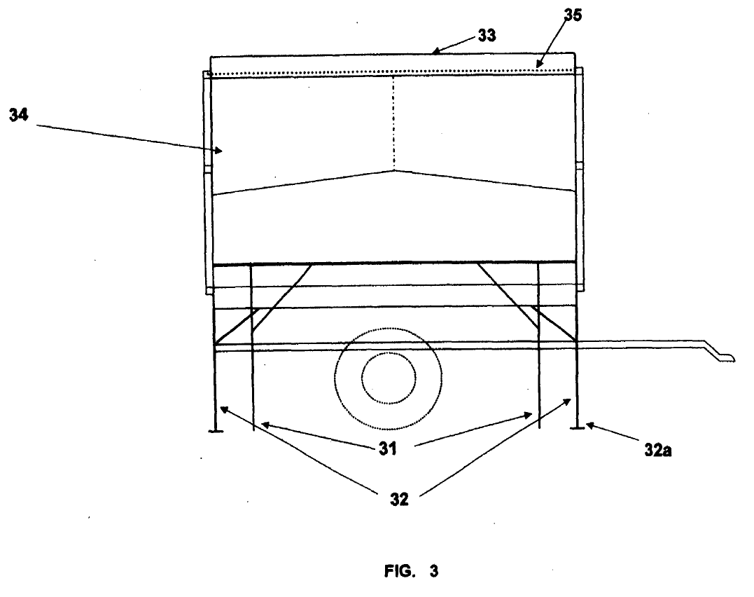

FIG. 2 is a rear view of the first embodiment of the trailer, without wheels or tires, in the folded position. Body doorway 21 may be partially seen: this is a partial doorway in the body itself rather than in the superstructure. Road safety equipment 22 may be lights, licenses, or other equipment as desired.

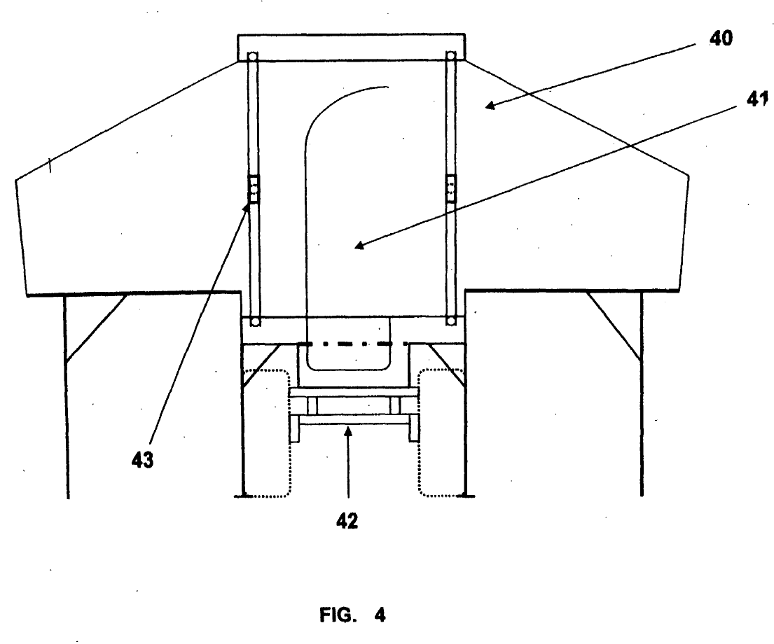

FIG. 3 is a side view of the first embodiment of the trailer of the invention, in the unfolded position. Bed panel support 31 and stabilizer 32 project downwards to the ground. Bed panel support 31 projects downwards from the bed panel to the ground. It will be appreciated that a stronger hinge mechanism may be used instead of bed panel support 31 in order to strengthen the extremely cantilevered width of the bed panel, however, more strength and less weight may be attained by means of a support at the outer edge.

Stabilizer 32 is designed to maintain the orientation of the vehicle when users move about inside or otherwise change weight distributions. Stabilizer foot 32a provides a greater surface area for the bottom end of the stabilizer 32, aiding it in not sinking into softer surfaces such as mud, sand, snow, etc.

Hard top 33 may serve as a cover for the superstructure 34 when the latter is folded down into the body for transport or storage. In this embodiment, hard top 33 may also serve as a central roof portion for the superstructure 34 when the superstructure is erected in the use position.

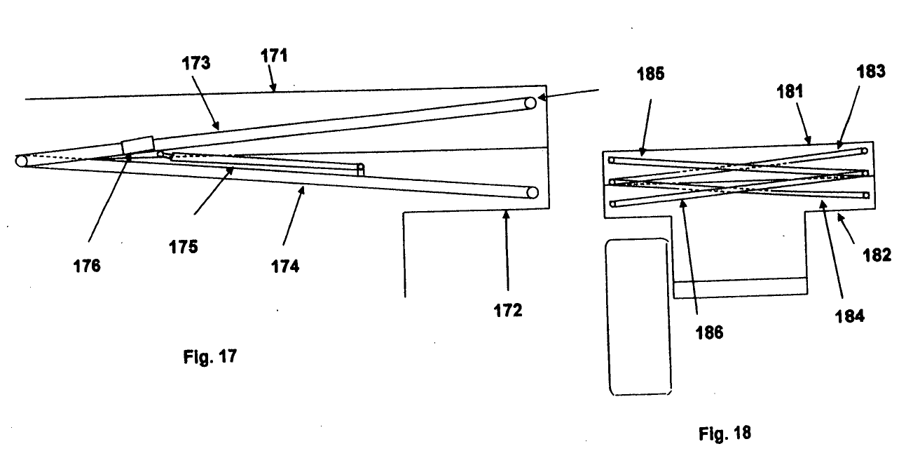

Torque transfer rod connecting rod 35 is attached to the upper lifting arms (FIGS. 16 and 17) through the hard top 33, thus keeping the lifting arms at different ends/corners at similar angles, thus allowing raising the superstructure from a single point of imposed force, such as a single person operating the device from one end.

In embodiments, hard top 33 may detach and have folding legs of its own, and may serve as a camping cot or camping table.

FIG. 4 is a rear view of the first embodiment of the trailer of the invention, in the unfolded position. Superstructure doorway 41 is a portion of the superstructure 40 which opens.

In preferred embodiments, the superstructure is a tent-like device of pliable materials such as fabrics, rubbers, plastics and polymers, metallized polymers, composites, etc. Canvas and nylon may be used for this. Superstructure doorway 41 then may be fastened with ties, snaps, zippers, hook and loop fabric and the like.

Suspension 42 is that portion of the vehicle connecting wheels and frame. In embodiments, this may simply be axle mounts, or may be other types of suspensions having leaf springs, shock absorbers of various types and so on.

Elbow locking sleeves 43 allow the straightened supports to fall into a locked configuration during a one person opening operation, and are shown in the locked position.

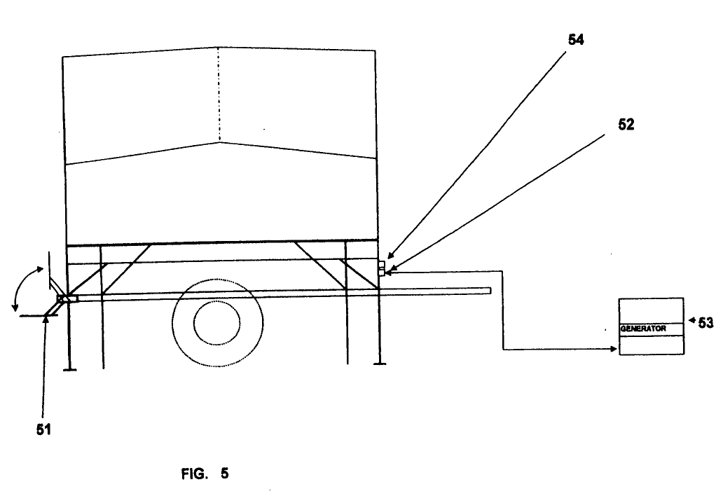

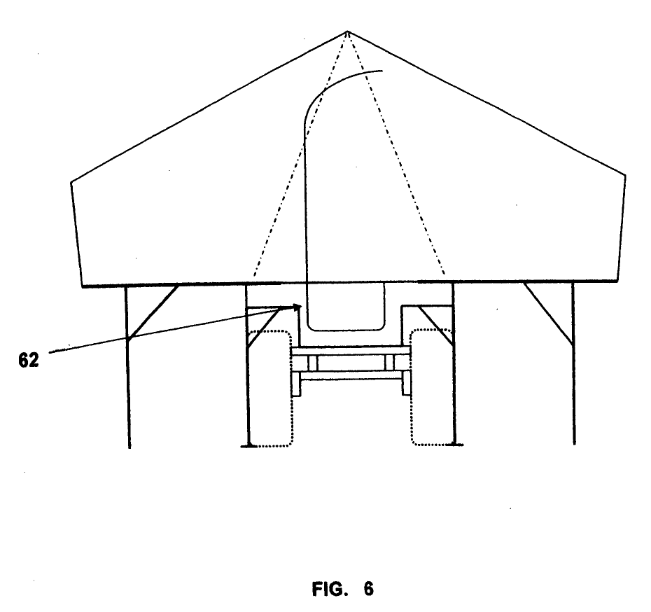

FIG. 5 is a side view of a second embodiment of the trailer of the invention, in the unfolded position, while FIG. 6 is a rear view of the a second embodiment of the trailer of the invention in the unfolded position. Folding step 51 allows easier access to the interior, which, as mentioned previously, has a quite high ground clearance unlike prior art “non-ATV camping trailers”. Electrical outlet panel 52 may advantageously be positioned on the outside of the body, so that a portable generator 55 may be employed to provide electricity to the invention. 12 VCD, 42V, 120 VAC, 240 VAC outlets and others may all be employed. The prior art discloses no suggestion that ATV features may be combined with a sleeping trailer and with electrical inlet features. Employment of the generator 55 is fairly straightforward: the generator is plugged into a standard electrical outlet but instead of drawing current therefrom, instead supplies current thereto. Other outlets inside/outside of the trailer may then draw power from the generator. Obviously, having the potentially noisy generator located outside of the superstructure and preferably at a distance is advantageous.

Hose bib 54 may allow connection of utilities such as clean water, grey or black water, gas, and so on, thus adding convenience of use in certain situations.

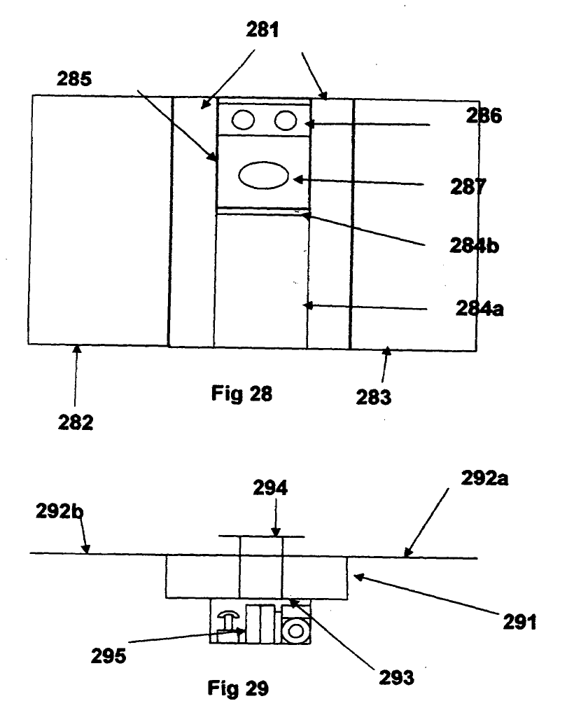

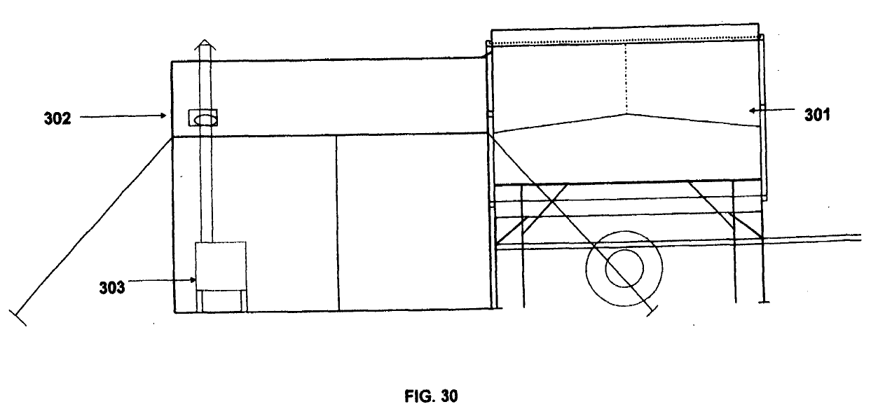

Camping equipment (see FIGS. 28 and 29 for further detail) may consist solely of the bed panels, or a storage locker, gun racks and lockers, stove, lantern, lights, toilet, equipment lockers, water, sink, electrical outlets, heater and the like, and is shown in the stored transport position below the bed panels. A second equipment position may allow this to be deployed, either separately or in tandem with the bed panels, to a use position.

Interior 62 may contain some of the camping equipment and camping equipment may be placed on the outside of the vehicle as well, for example, taps for showers, folding seats, and the like.

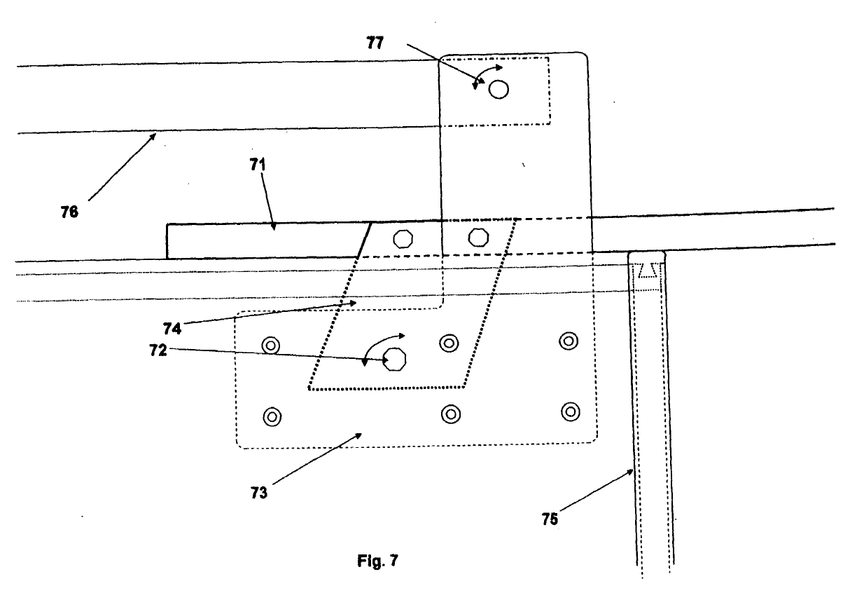

FIG. 7 is a detail partial view of a first side hinge allowing unfolding of the trailer and first side bed. Right bed panel 71 supports a mattress thereon, the mattress may in preferred embodiments be secured so as not to fall off when the panel is rotated through its full range of motion.

Pivot 72 allows the panel 71 to rotate from at least one closed position substantially atop the camping equipment inside of the interior of the body and interior of the superstructure, in which position the beds do not project nor cause the device to exceed the size and shape of an ATV, and may rotate to at least one open position cantilevered out from the side of the vehicle to allow access to the interior of the body and the interior of the superstructure and the camping equipment within those interior spaces (which adjoin and may be considered to be one larger interior space).

Hinge plate 73 holds the pivot 72. Hinge arm 74 is useful in presently preferred embodiments in which there are two beds. While one side of the trailer may simply be made higher than the other side of the trailer so that the folded beds from opposite sides fold to different levels atop the body, it is more aesthetically pleasing to provide hinge arm 74 which offsets the bed panel 71 from the elevation of the pivot 72, so that when folded, the bed is lower than the pivot 72, and when unfolded, the bed is higher than the pivot 72.

Right side 75 may thus be the same height as the other side, and yet the beds will fold and sit one atop the other.

Pivot 77 allows a superstructure support member 76 to fold down when not in use and up when in use.

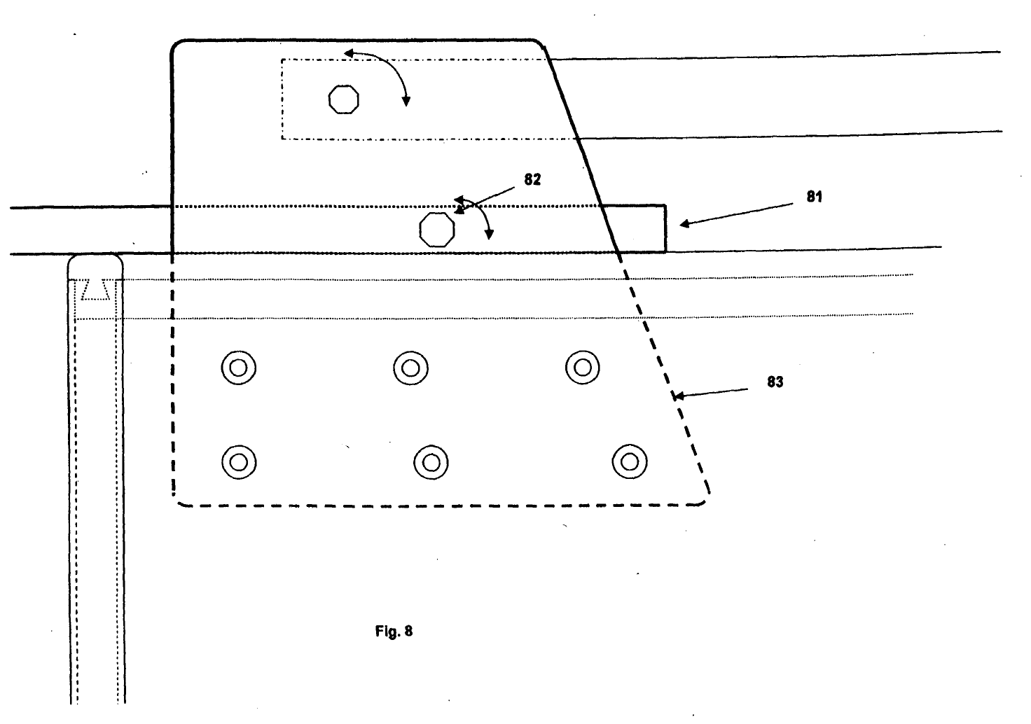

FIG. 8 is a detail partial view of a second side hinge allowing unfolding the trailer and second side bed. Left bed panel 81 has pivot 82 again allowing approximately 180 degrees of rotational motion as pivot 72 does, and is also secured by hinge plate 83. However, this bed sits more closely at the level of pivot 82, thus if pivot 82 and pivot 72 are at the same level, the beds when folded from left and right sides may be at different heights.

FIG. 9 is a detail partial view of one extendible yoke of the invention. Side rails 91a, 91b are a portion of the frame. The frame may be made of materials such as 2 inch cross section tubing of strong construction, solid metal, wood, etc, though tubing or beams present obvious advantages. Cross beams 92a, 92b may be of similar construction.

Yoke extending portion 93 seats to yoke fixed portion 94 and may rotate at hinge pin 95 seated in yoke pin hole 96. Pin 95 may be removable or may be permanently installed.

Pull pin 97 is moveable and secures the yoke extending portion 93 in rigid relation to the frame and yoke fixed portion, allowing secure towing. However, while spring 98 biases pull pin 97 into the position in which it secures the yoke, pull pin handle 99 allows application of tension to the pull pin 97 and thus spring 98, allowing the pull pin to be retracted, which in turn allows the yoke extending portion to swing, telescope, slide, detach or otherwise change its physical relation to yoke fixed portion 94 and the trailer frame.

This moveable yoke is of importance in this ATV trailer. A long yoke is desirable for off road work, during which the ATV and the ATV camping trailer may become oriented at different angles. However, a long yoke violates the limitation of the ATV camping trailer to the same size and shape as the ATV. A fixed long yoke will require excessive space for storage and transport. Thus, the present invention uses a moveable/extendible/removable yoke portion 93 to allow both convenient and safe towing and also convenient storage and transport.

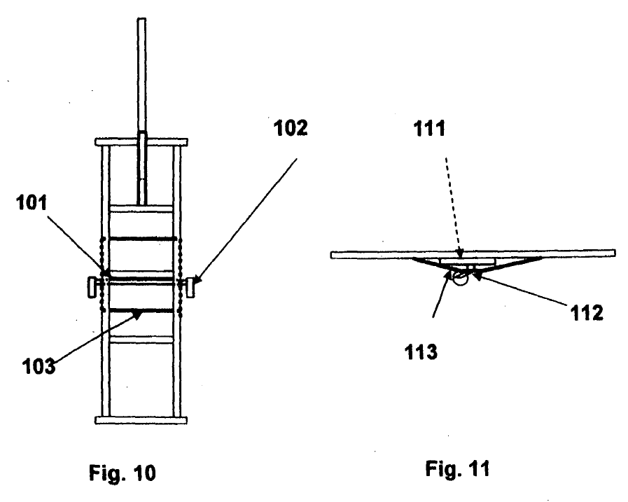

FIG. 10 is a planform view of the framework, skid plate and axle of the invention. Torsion axle mount 101 secures a torsion axle 102 of the preferred embodiment. Other axles may be used, for example, rigid axles with a leaf spring suspension and the like, and still fall within the ambit of the attached claims. Skid plate 103 protects the axle or other suspension system at times when the device may ground out on rough terrain or obstacles.

FIG. 11 is a side view (yoke omitted) of the framework, skid plate and axle of the invention. Torsion axle mount 111, torsion axle 112 and skid plate 113 may be seen in side view, and it is seen that skid plate 113 may of necessity be a relatively heavy device such as a single sheet of heavy gauge metal.

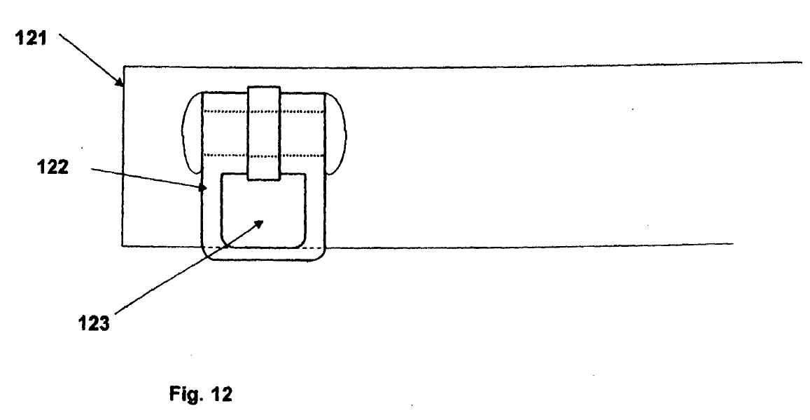

FIG. 12 is a detail view of an auxiliary tow loop of the invention. Frame member 121 provides a secure attachment point for tow loop 122 having aperture 123 which in turn provides a secure alternative attachment point for towing. Frame member 121 may be a side rail or a cross piece or a portion of the yoke. This alternative may be an alternative embodiment for towing, however, in the best mode now contemplated, both the moveable yoke and the auxiliary tow loops are used. This is because off road towing (for example over logs or boulders) may place the ATV and the ATV camping trailer at such an angle that even the long yoke provided does not allow safe or convenient towing. Then the auxiliary tow loops, which may be located at corners, ends or sides of the invention away from the yoke, may be employed for a different tow.

FIG. 13 is a partial side view of a stabilizer bar and adjoining area of the invention. Fixed stabilizer portion 131 cooperates with extending stabilizer portion 132 and stabilizer brace 133 and stabilizer pivot 134 to provide a leg which may be raised to the body of the trailer or extended to the ground. As noted in regard to FIGS. 3/4, the stabilizers prevent the trailer from swaying when the weight distribution therein changes, for example, from an individual placing a game animal in/on the vehicle or walking about inside. Also as noted in regard to FIGS. 3/4, the stabilizers may have feet attached at the bottom end.

The stabilizers may telescope, swing, detach, slide or otherwise move from a stowed position in or under the body to a use position as shown in FIG. 13. FIG. 14 is a partial rear view of a stabilizer bar and adjoining area of the invention. Fixed stabilizer portion 141 and extending stabilizer portion 142 and stabilizer brace 143 may cooperate to provide such stabilization.

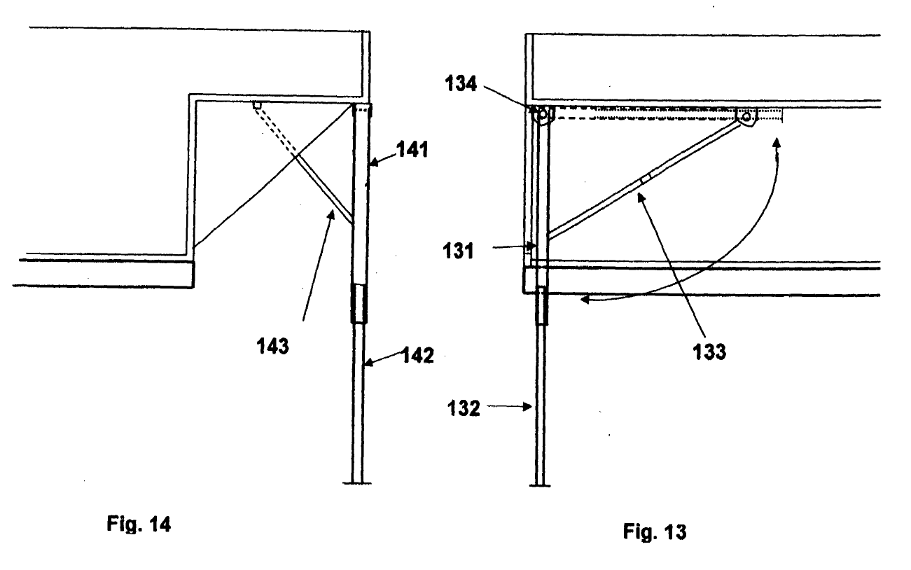

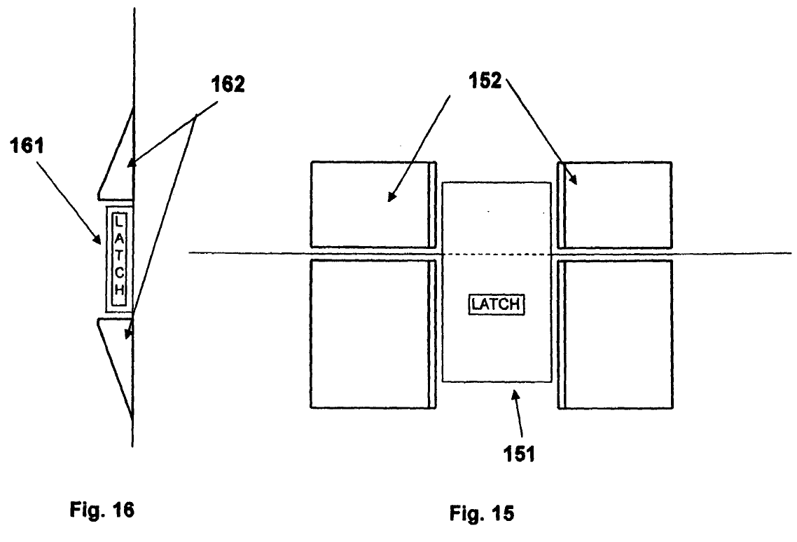

FIG. 15 is a detail side view of a latch of the invention showing latch guards. Latch 151 may have latch protector 152 protecting the latch from glancing blows to the ATV trailer as it is maneuvered past obstacles off road, for example, tree branches, rock projections and so on. FIG. 16 is a detail plan view of a latch and latch guards of the invention. Latch 161 has latch protector 162 which may be located in front of, behind, above or below the latch, and as shown there may be more than one latch protector which sits in two directions. Some sort of securing device is necessary to secure the lid in place during tow, when the entire trailer is likely to suffer impact, shock, and snagging on rocks, trees, etc.

FIG. 17 is a partial end view of trail box in first folded position depicting a portion of the superstructure raising mechanism for a particular embodiment. Reference no. 171 represents the exterior of the lid portion of the trailer in the first folded position. Reference no. 172 represents a portion of main body of trailer. When in the first folded position and secured with latches depicted in FIG. 15, the lid (top) and body may create a weather resistant seal utilizing a rubber type membrane affixed to the body through an extruded channel in the body material edge cap. Reference no. 173 is an upper lift arm pivoting at the top end connection fixed to the lid 171, and pivoting at the lower end to the upper portion of a lower lift arm 174 which is pivotally connected to the trailer body at it's lower end. Reference no. 175 is a gas shock connected between upper lift arm 173 and lower lift arm 174 in a manner such that when latches (151) are released the lid 171 may be raised with minimal effort due to the assistance of the compressed gas lift shock 175. Reference no. 176 is an elbow locking sleeve which is held in the current position via spring loaded locking button. Previously mention torque transfer connecting rod may be connected to the upper lift arm top pivot as displayed in FIG. 3.

FIG. 18 is an end view of the trailer in a particular embodiment in the first folded position. 181 is the lid or top portion of the superstructure in this particular embodiment as described in reference to FIG. 17. Reference no. 182 is the trailer box portion. Reference numerals 183 and 184 are the upper and lower lift arms for the right side of this end and lift arms 185 and 186 are the lift arms for the left side of this particular end. One set of lift arms (right or left) may be extended from the trailer a distance to allow the other set of lift arms to fold in a position closer to the trailer structure as to allow the raising and lowering of the superstructure without interference of the two sets of lift arms. A duplicate set of lift arms may be fixed to the opposite end of the trailer. Each set of lift arms may include a gas shock and elbow locking sleeve.

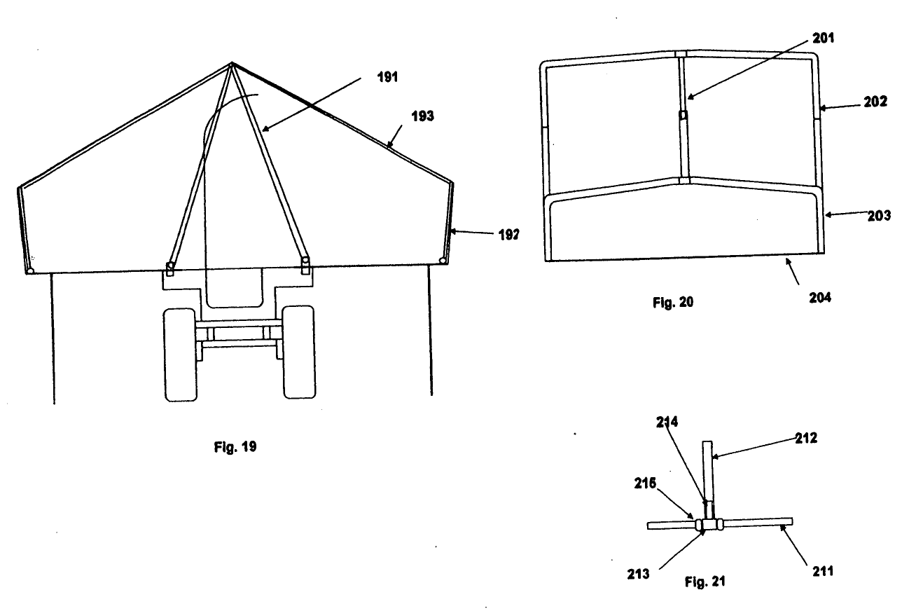

FIG. 19 is a view of a second embodiment of the invention depicting a canopy raising method and apparatus. Telescoping ridge support 191 raises from a first folded position to the second unfolded position shown and extends the unfixed portion to a length which is required to provide interior space for camper to stand and move about the cabin. Side canopy support 192 is pivotally fixed to the bed panel at or near the most exterior edge when in the second folded position. Side canopy support raises from a first position in which it is positioned on the bed mattress by pivoting to a position as shown to make room for at least one person to lay prone on the bed while protected from weather by the canopy. Ridge to end/side canopy support 193 is brought from a movable free position to the position shown to support the canopy and secure side canopy support 192 into place utilizing an extending and locking (telescoping) mechanism.

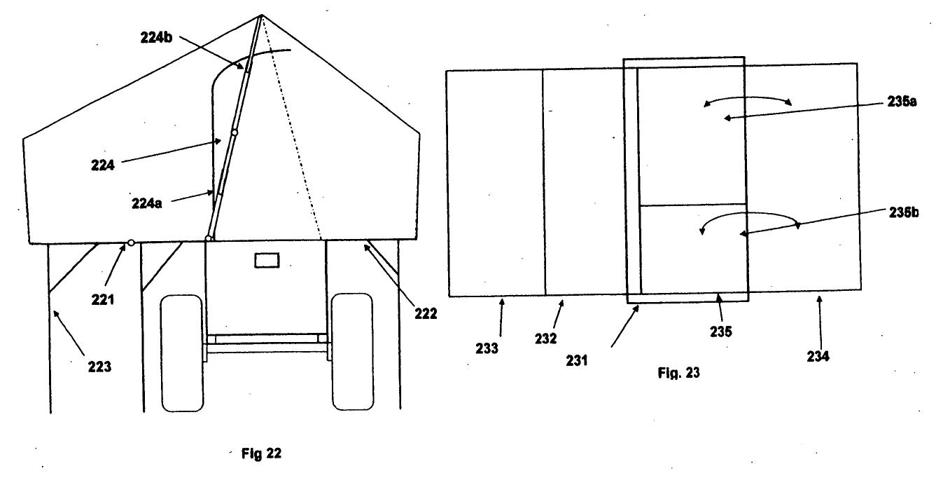

FIG. 20 is a side view of the canopy support system for this embodiment in the second folded position. Ridge to side canopy support 201 is extended and compressionally fixed to ridge support 202 and side canopy support 203. This is shown in FIG. 21. Ridge support 202 runs along the axis of fold of the superstructure in this embodiment, but may run other directions in other embodiments, and supports the actual ridgeline of the superstructure.

Side canopy support 203 is pivotally fixed to bed panel 204, and helps to support the superstructure in an open configuration.

FIG. 21 depicts side canopy support 211 fixed to ridge-to-side canopy support 212. This is accomplished by rotatable sleeve 213 with fixed round protruding guide peg 214 on side canopy support 211. The lower end of the ridge-to-side canopy support has a round receiver which may externally engage the guide peg 214. Sleeve 213 is held laterally in place on side canopy support by compression bushings 215. Ridge-to-side canopy support is held in place by compressional forces created through the extension of the telescoping mechanism of 212. A similar peg and receiver apparatus is utilized at the ridge support connection with the ridge-to-side canopy support.

FIG. 22 depicts an embodiment with bi-fold bedding platform 221 on one side and single bedding platform 222 on the opposite side. This embodiment would allow at least one person to lie prone on a bedding platform—which may include a mattress—the bedding platform perpendicular to the folding axis of the beds. Additional bed support 223 may be utilized on the most exterior bed panel. This embodiment may allow for a more compacted first folding position and require less material to construct. This embodiment may utilize similar frame, suspension and yoke designs as other embodiments. The ridge canopy support 224 may have a telescoping lower portion 224a and telescoping second portion 224b pivotally joined to allow compact folding and storage in the first folded position and sufficient interior room in the second folded position. Previously described canopy support mechanisms may also be utilized.

FIG. 23 is a plan view of an embodiment in a second folding position of a trailer body 231. Bi-fold bed panel interior section 232 and exterior fold bed panel 233 are hinged to the side of body 231 as previously discussed. Opposite side bed panel 234 is opened allowing bed panel 235 to be folded from off of the bed panel 234 to provide space for at least one person to lay prone perpendicular to the folding axis of the bed panels. Bed panel 235b can be left in the first folded position on bed panel 234 to allow room to for person to stand on floor or sit on bed panels 235a or 232 with feet on floor of trailer interior. Bed panel 235b may then serve as a table.

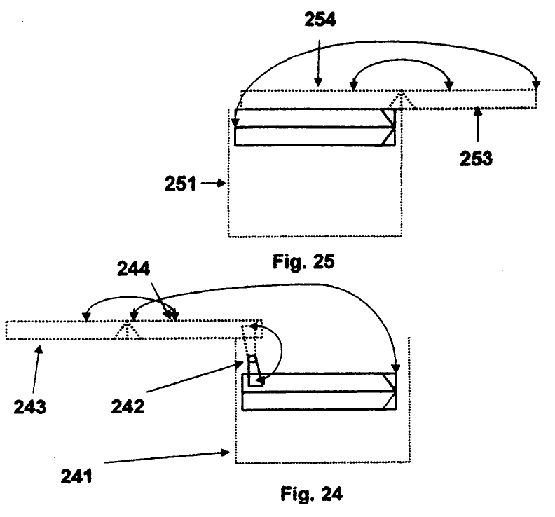

FIG. 24 shows bi-fold bedding platforms and mattress in first stored position, and the in second folded position. FIG. 25 shows single bed platform with second bed platform in initial stored folding position, and then in second folded position. Bodies 241, 251 have the beds folded within them, available for unfolding into a second position. Bed panels 243, 244 fold out on extension hinge 242, thus allowing them to sit a first depth deep into body 241, while bed panels 253, 254 have a hinge that does not have this extension, so that they sit at a second depth into the body 251. The second depth may be less deep than the first depth.

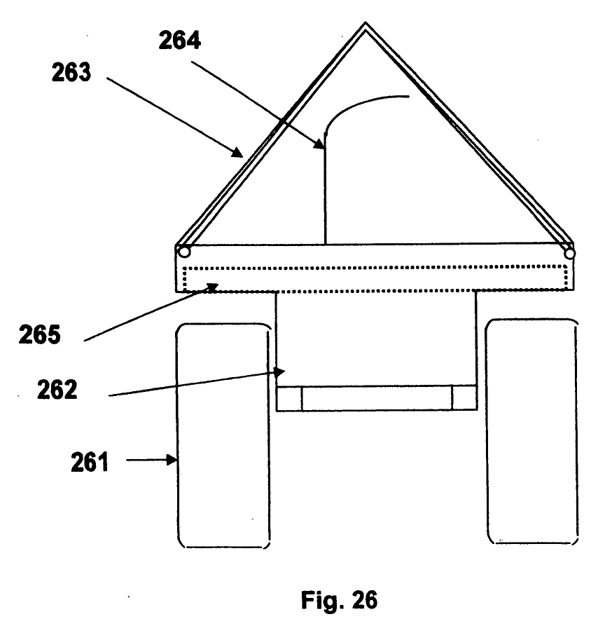

FIG. 26 is a rear view of trailer showing body 262 and tire 261. Exterior superstructure lift arms 263 are shown in a second unfolded position. Door 264 may be used to access the interior of the superstructure/body. Bed 265 in this embodiment may not fold out of the body 262 at all: the bed may be fixed and used without folding. This embodiment is of lower cost and is easier to use, however, it offers less space to the user.

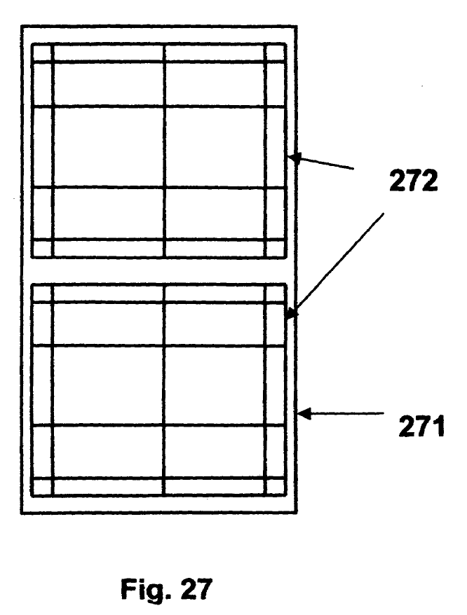

FIG. 27 shows a planfrom view of top of trailer 271. Top cargo rack 272 has two portions in this embodiment and may have three portions in a preferred embodiment. Top rack is made of round tubular steel and raised above the top panel to allow securing cargo using elastic cords or rope. Cargo racks may have a base of similar material that may distribute load to top panel in a pattern fitting inside the exterior of the rack by a small margin.

It will be seen that the superstructure and various superstructure supports (ridge, ends, etc) are depicted in the folded position in this diagram.

FIG. 28 is a plan view of a sixth embodiment of the invention, showing interior options. The shape of the vehicle body may be used to provide cantilevered side interior seats 281 or shelves, tables, etc in the same location. First bed 282 and second bed 283 are shown in the unfolded position. Table 284a may convert the interior space into a booth, or may be smaller than the general space of the interior or the space of the “well” between the cantilevered sides. Oven 284b may be built into the stove.

Interior well 285 is the deeper space defined between the cantilevered sides. The may be used for storage of camping equipment, or it may be used as a walkway, or it may be used a the space under a table (as shown), or it may be used to hold fixed camping equipment such as stove 286, also as shown, for a combination of these uses.

Sink 287 may be fed by internal water storage or may be fed from a hose bib as discussed previously.

FIG. 29 is a rear view of the sixth embodiment of the invention, showing interior options. Cantilevered sides 291 in this embodiment are foot wells, unlike the embodiment of FIG. 28. Seating is on beds 292a, 292b, and floor panel 293 may be lifted to provide access to storage compartment 295. Equipment/well 295 shows both the well and the possibility of using at storage space for camping equipment. Table 294 may be supported on floor panel 293 as shown or in another manner.

FIG. 30 is a side view of a seventh embodiment of the invention. Superstructure 301 may connect or be a unitary flexible material with external tent 302 which may vastly increase the interior space of the vehicle. Note that this configuration may stow away into the well space and/or interior of the body, thus allowing a simplified setup and take-down procedure. The external tent may be separate and may have zip, button, snap, hook and loop fabric or other connectors allowing it to be used or not used as desired by circumstances.

Stove/heater 303 is one example of the camping equipment possible for affixation within the external tent: the complete list includes all of the camping equipment discussed in this application.

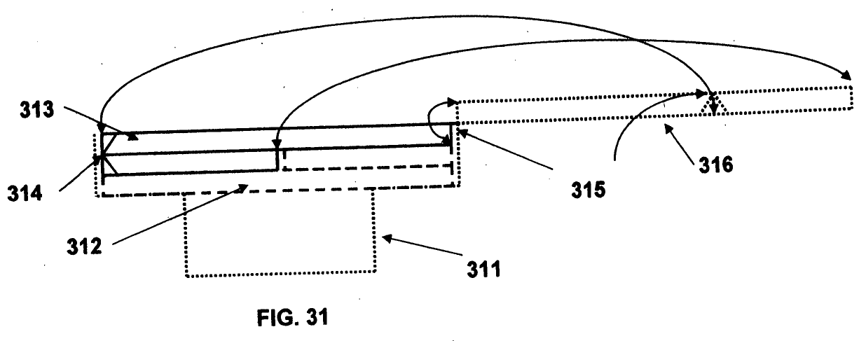

FIG. 31 is a partial rear view of an eighth embodiment of the invention, showing a queen size folding bed embodiment. Body 311 contains not two but three layers of bed panels. First bed panel 312 is lowest, and is connected by a flexible mechanism such as cloth or a hinge to a second bed panel. Third bed panel 313 is hingedly connected 314 to a fourth bed panel. Folding mechanism or hinge 315 allows the first two bed panels to unfold to position 316.

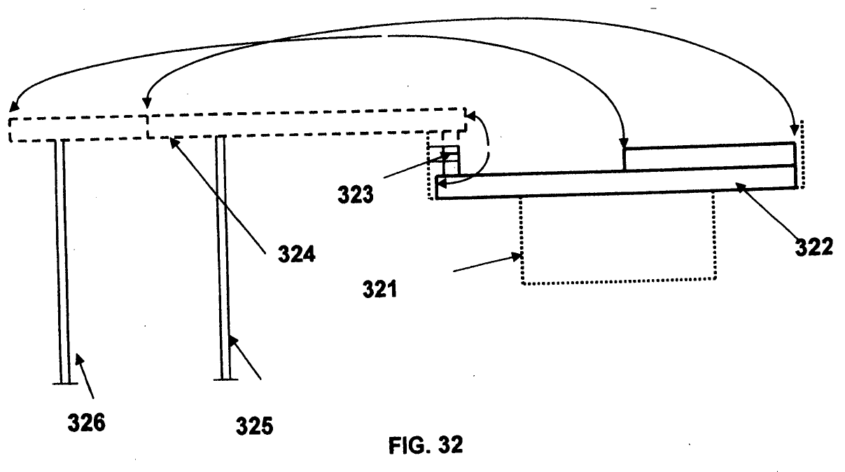

FIG. 32 is a partial rear view of the eighth embodiment in a different state of unfolding. Side 321 is as discussed previously. Second bed first panel 322 and second bed extension hinge 323 may allow a considerably larger bed surface: experimentation has revealed that a Queen size mattress may be used, thus comfortably allowing more than one individual to sleep in one bed, and a plurality of individuals greater than two to use the camper of the invention. Secondary panel hinge 324 allows the larger bed size.

Second bed first panel support 325 and second bed second panel support 326 may be necessary or preferable in order to provide greater life span of the hinge system: one set of supports for each bed panel may be necessary or desirable for almost any size of bed.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. An improved camping trailer wherein the improvement comprises:
an ATV-size body having a width no greater than 50 inches and a length no greater than 90 inches.

2. An ATV trailer comprising:
1) an ATV-size body having a front and a back and a bottom and a left side and a right side, the body having a width of no greater than 50 inches and a length of no greater than 90 inches;
2) the body meeting US governmental regulations differentiating trail-legal trailers from street-legal trailers by being trail-legal and not street-legal;
3) at least two wheels, each wheel having thereon at least one low inflation tire; one wheel disposed at each side of the body;
4) a foldable superstructure on the body, the superstructure having a first folded position and a second unfolded position in which the superstructure has an interior and an exterior;
5) a first bed affixed to the body within the interior of the superstructure.

3. The ATV trailer of claim 2, further comprising:
5) a towing yoke having a first position having a first length and a second position having a second length.

4. The ATV trailer of claim 2, further comprising:
6) a torsional axle connected to the body and wheels.

5. The ATV trailer of claim 4, wherein the axle and wheels are dimensioned and configured to maintain the bottom at least ten inches (25 cm) above the lowest point of the low inflation wheels.

6. The ATV trailer of claim 2, wherein the bed further comprises a first folding bed having a substantially flat surface and at least one edge, the first folding bed having at least one hinge rotatably connecting the one edge of the first folding bed and a first side of the body, so that when the superstructure is in the first folded position the bed is co-located in plane with the body and when the superstructure is in the second unfolded position the bed extends horizontally from the first side of the body.

7. The ATV trailer of claim 6, wherein the superstructure further comprises a second folding bed having a substantially flat surface and at least one edge, the second folding bed having at least one hinge rotatably connecting the one edge of the second folding bed and a second side of the body, so that when the superstructure is in the first folded position the bed is atop the first folding bed and when the superstructure is in the second unfolded position the bed extends horizontally from the second side of the body.

8. The ATV trailer of claim 2, further comprising:
a skid plate located under the axle and attached to the frame.

9. The ATV trailer of claim 2, further comprising:
at least one stabilizer having a first position and a second position, the stabilizer in the first position rigidly extending from the ATV trailer to the surface on which it sits.

10. The ATV trailer of claim 2, further comprising:
at least one bed panel support having a first position and a second position, the bed panel support in the first position rigidly extending from the ATV trailer to the surface on which it sits.

14. The ATV trailer of claim 2, further comprising:
7) camping equipment affixed to the body within the interior of the superstructure.
